(19) United States
(12) Patent Application Publication
(10) Pub. No.: US 2005/0147028 A1
(43) Pub. Date: Jul. 7, 2005

(54) High-availability router redundancy method and apparatus

(75) Inventors: Seung-Gu Na, Yongin-si (KR); Yong-Keon Kim, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 10/995,129

(22) Filed: Nov. 24, 2004

(30) Foreign Application Priority Data
Jan. 5, 2004 (KR) 2004-260

(51) Int. Cl. H04L 12/26

(52) U.S. Cl. 370/217

(57) ABSTRACT

A redundancy method and apparatus for a default router of hosts in a local area network (LAN). The router redundancy system includes an active router and at least one standby router. The active router transmits a periodic advertisement message. The standby router determines whether a periodic advertisement message is received from the active router within a predetermined timeout period, and repeatedly transmits a heart beat message to the active router a predetermined number of times if the advertisement message is not received. After repeated transmission of the heart beat message, the standby router transitions to an active state if a response to the heart beat message is not received within a predetermined waiting time.

### PRIORITY

This application claims the benefit under 35 U.S.C. § 119(a) to an application entitled “High-Availability Router Redundancy Method and Apparatus” filed in the Korean Intellectual Property Office on Jan. 5, 2004 and assigned Serial No. 2004-260, the entire contents of which are incorporated herein by reference.

### BACKGROUND OF THE INVENTION

1. Field of the Invention

The present invention relates generally to a local area network (LAN). In particular, the present invention relates to a redundancy method and apparatus for a default router of hosts.

2. Description of the Related Art

A typical local area network (LAN) is connected to another local area network via one or more routers, and allows a host such as a personal computer (PC) or a repeater disposed in the local area network to communicate with another host on another local area network. Routers receive data packet having a destination address, and forward the data packet to the destination address via the shortest path.

In a local area network environment, for communicating with an external network, hosts recognize only one default router. A host desiring to transmit data packets to an external address transmits the data packets to the default router. However, a router may fail to perform for several reasons such as power failure, re-booting, scheduled maintenance, and so on. Therefore, if a failure occurs in the default router, the host cannot communicate with an external network.

In order to solve the above problem, in Virtual Routing Redundancy Protocol (VRRP) specified in Request For Comments (RFC) 2338 and Hot Standby Router Protocol (HSRP) specified in RFC2281 which are both incorporated by reference in their entirety, a host using a fixed default router has one active router and one or more standby routers. The standby routers are called a “standby group,” and one router selected from the standby routers is used for the host.

The active router periodically sends an advertisement message in order to inform the standby router of its availability, and the standby router receiving the advertisement message recognizes the availability of the active router. If the active router cannot send the advertisement message any longer due to its failure, the standby router recognizes that the failure occurred in the active router because of the interruption of the advertisement message, and the standby router then serves as an active router.

A typical method for detecting via a standby router that a failure occurred in an active router in the local area network environment will be described herein below.

A standby router recognizes a failure occurred in an active router if the standby router fails to receive any advertisement message for a duration of about 3 times a transmission period of an advertisement message transmitted by the active router. Usually, a period for which the active router sends the advertisement message is 1 sec, 2 sec, and so on. In order to recognize that the failure occurred in the active router, the standby router should wait for 3 seconds or more for a 1-second period, and 6 seconds or more for a 2-second period. Therefore, for this time period, both the active router and the standby router cannot serve as a default router, so that the hosts experience communication interruption.

Accordingly, there is a demand for technology for securing a high-availability router by minimizing a recovery time from the time of an occurrence of a failure of an active router to the time a standby router takes over. This can be accomplished by resolving the defects of the existing router redundancy protocol.

### SUMMARY OF THE INVENTION

It is, therefore, an object of the present invention to provide a high-availability router redundancy method and apparatus for minimizing a recovery time from the time of an occurrence of a failure of an active router to the time a standby router takes over.

It is another object of the present invention to provide a router redundancy method and apparatus for reducing a timeout time of an advertisement message received from an active router to ⅓ the original timeout period, and detecting that a failure occurred in the active router as quickly as possible based on a heart beat message from a standby router.

In accordance with one aspect of the present invention, there is provided a state transition method by a standby router in a router redundancy system including an active router and at least one standby router. The method comprises determining whether a periodic advertisement message is received from the active router within a predetermined timeout period; upon failure to receive the advertisement message, repeatedly transmitting a heart beat message to the active router a predetermined number of times; and transitioning to an active state if a response to the heart beat message is not received within a predetermined waiting time after repeated transmissions of the heart beat message.

In accordance with another aspect of the present invention, there is provided a router redundancy system comprising an active router for transmitting a periodic advertisement message; and at least one standby router for determining whether a periodic advertisement message is received from the active router within a predetermined timeout period, repeatedly transmitting a heart beat message to the active router a predetermined number of times if the advertisement message is not received, and transitioning to an active state if a response to the heart beat message is not received within a predetermined waiting time after repeated transmissions of the heart beat message.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a network configuration for an operation of a router redundancy protocol;

FIG. 2 is a diagram illustrating an internal structure of a host or a router illustrated in FIG. 1;

FIG. 3 is a message flow diagram illustrating a router switching operation based on a conventional router redundancy protocol;

FIG. 4 is a message flow diagram illustrating a router switching operation based on a router redundancy protocol according to an embodiment of the present invention;

FIG. 5 is a flowchart illustrating an operation of a standby router according to an embodiment of the present invention; and

FIG. 6 is a diagram illustrating a comparison between a conventional technology and an embodiment of the present invention in terms of an expected recovery time based on a variation in duration of an advertisement message.

Throughout the drawings, it should be noted that the same or similar elements are denoted by like reference numerals.

### DETAILED DESCRIPTION OF THE PREFERRED EMBODIMENTS

Embodiments of the present invention will now be described in detail with reference to the accompanying drawings. In the following description, a detailed description of known functions and configurations incorporated herein has been omitted for conciseness.

In router redundancy technology, a plurality of default routers are duplexed (or dualized) into active/standby routers in a local area network (LAN), and when a failure occurs in an active router, a standby router detects the failure and takes over a function of the active router, thereby providing redundancy.

Before a description of a structure and operation of embodiments of the present invention is given, the terms used herein will be defined herein below.

A host refers to a personal computer (PC) or another network entity, disposed in a local area network, which communicates with external network entities via a router or bridge. A router refers to hardware of a network layer that operates to forward data packets between several local area networks. The network layer generally delivers packets by connecting a path via a series of nodes by a pair of entities in a network.

An Internet protocol (IP) address refers to an address of a network layer for an apparatus that operates according to an IP protocol. A typical IP address comprises 32 bits or 64 bits at least one part of the IP address including information corresponding to a particular network element. Therefore, an IP address of a router can be changed according to its location in a network.

Data packet or packet refers to an aggregate of data and a control message, including an address of a source node and an address of a destination node, constructed such that it can be transmitted from one node to another node.

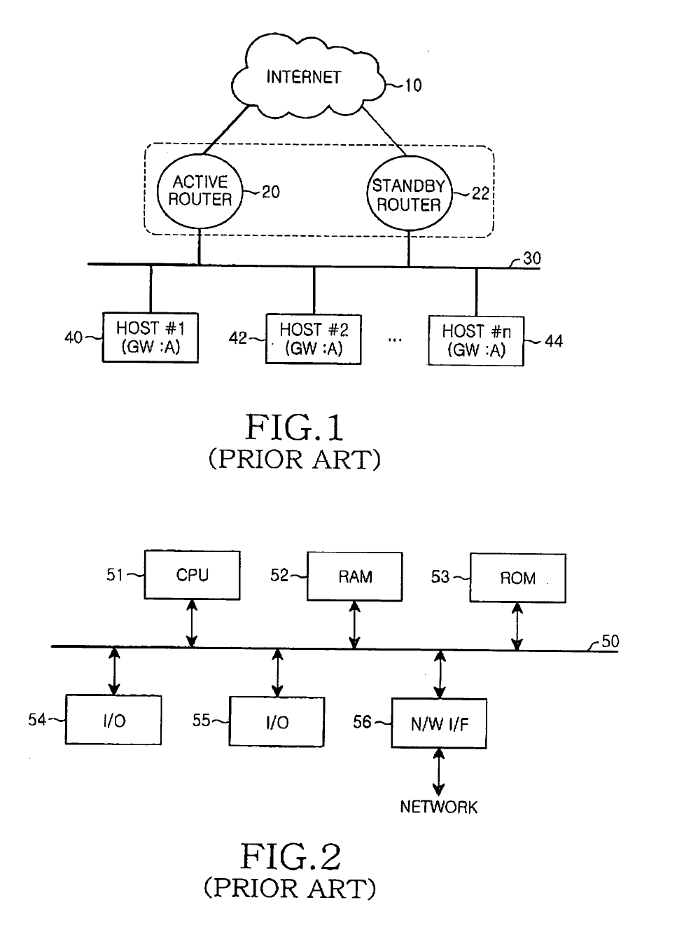

FIG. 1 is a diagram illustrating a conventional network configuration for an operation of a router redundancy protocol. As illustrated, a plurality of hosts 40, 42 and 44, one active router 20, and one standby router 22 are connected to a local area network (LAN) 30. The active router 20 or the standby router 22 is connected to the Internet 10 to allow network elements connected to the local area network 30 to communicate with other network elements of an external network, i.e., the Internet 10.

The active router 20 and the standby router 22 serve as a virtual router of the hosts 40 to 44 using a virtual IP address ‘A’. The hosts 40 to 44 set a default router, i.e., a gateway, to an IP address A, and forward packets via the active router 20 before the occurrence of a failure. If a failure occurs in the active router 20, the standby router 22 detects the occurrence of a failure and then, takes over a function of the active router 20, serving as a default router of the hosts 40 to 44.

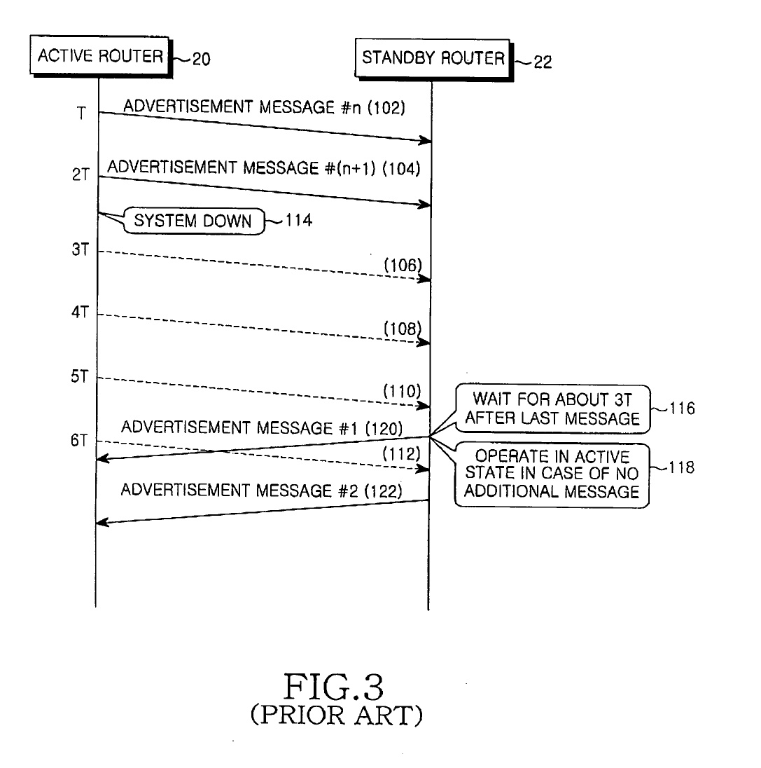

FIG. 2 is a diagram illustrating a conventional host or router illustrated in FIG. 1. The host or router illustrated in FIG. 1 comprises a central processing unit (CPU) 51, a random access memory (RAM) 52, a read only memory (ROM) 53, a network interface (N/W I/F) 56, various input/output devices (I/O) 54 and 55, and a bus 50 for connecting the above elements to one another.

In case of a transmission/reception host, the network interface 56 is used for connection to a default router for network access, and in case of a router, the network interface 56 is used for connection to a transmission/reception host or another router. Although FIG. 2 shows a specific example of a structure of a host or a router, the embodiments of the present invention are not restricted to this structure.

FIG. 3 is a message flow diagram illustrating a router switching operation based on a typical router redundancy protocol. Herein, a message exchange between an active router and a standby router is represented by a time line.

Referring to FIG. 3, in steps 102 and 104, an active router transmits an advertisement message to a standby router every period T and 2T. If the active router continuously maintains a normal state, the active router continuously transmits an advertisement message by periods at 3T, 4T, 5T and 6T in steps 106 to 112. The standby router maintains a standby state while it receives the periodic advertisement message.

If a failure such as a system down occurs in the active router in step 114 and thus the active router can no longer transmit an advertisement message, then the standby router waits for a predetermined timeout time after the last advertisement message in step 116. For example, it is prescribed in VRRP and HSRP that the timeout time should be set to a value which is larger than 3 times the duration of an advertisement message. In case of VRRP, the timeout duration is set to the sum of 3 times the duration of an advertisement message and a skew time shorter than one period. For example, if a period of the advertisement message is 1 second, the standby router waits for a minimum of 3 seconds.

If no additional advertisement message is received until the timeout time expires, the standby router operates as an active router in step 118 and then transmits a periodic advertisement message in steps 120 and 122. In this case, the previous active router switches to a standby router and receives the advertisement message to determine whether it will switch back to the active router.

In a conventional router redundancy structure operating in this manner, a standby router waits for at least the timeout time. This means that a time for the timeout is required before a recovery is achieved, so that during that time, a host cannot transmit any data packet.

In an embodiment for preventing such a problem, a timeout duration of an advertisement message used in a standby router is set to a relatively short duration, while a failure occurring in an active router is detected as fast as possible by a heart beat message from the standby router.

In an embodiment of the present invention, the timeout period is set to the sum of a duration of the advertisement messages and 4 round trip times (RTT), i.e., 4*RTT. The RTT represents a duration of time required for packet trips between routers. A timeout period of a margin of 4*RTT is provided because transmission of an advertisement message can be delayed due to a load of a network or a system. That is, if a standby router fails to receive an advertisement message within about one period (T+4RTT) of the advertisement message, not three periods of the advertisement message, then the standby router considers that an active router is abnormal.

The standby router may fail to receive an advertisement message for the timeout period for the following two reasons. First, the standby router fails to receive an advertisement message for the timeout period when the advertisement message transmitted by the active router is lost. Second, the standby router fails to receive an advertisement message when the advertisement message was not transmitted due to system down situation of the active router. In order to find out the reason, a process of analyzing a heart beat message is required.

When making a transition to an active mode, the standby router first generates a heart beat message and waits for a response from the active router. If the active router fails to respond to the heart beat message, it indicates that the active router cannot perform a normal operation. However, if the active router responds to the heart beat message, it indicates that the active router can perform a normal operation but the advertisement message was lost during transmission. In this case, there is a possibility that even the heart beat message cannot be delivered to the active router due to it being lost. Therefore, the standby router repeatedly transmits the heart beat message three times, and thereafter, if no response to the heart beat message is received, the standby router considers that the active router cannot perform a normal operation. In an embodiment of the present invention, a time for waiting for a response to the heart beat message is set to 4*RTT which is similar to a timeout time of the advertisement message.

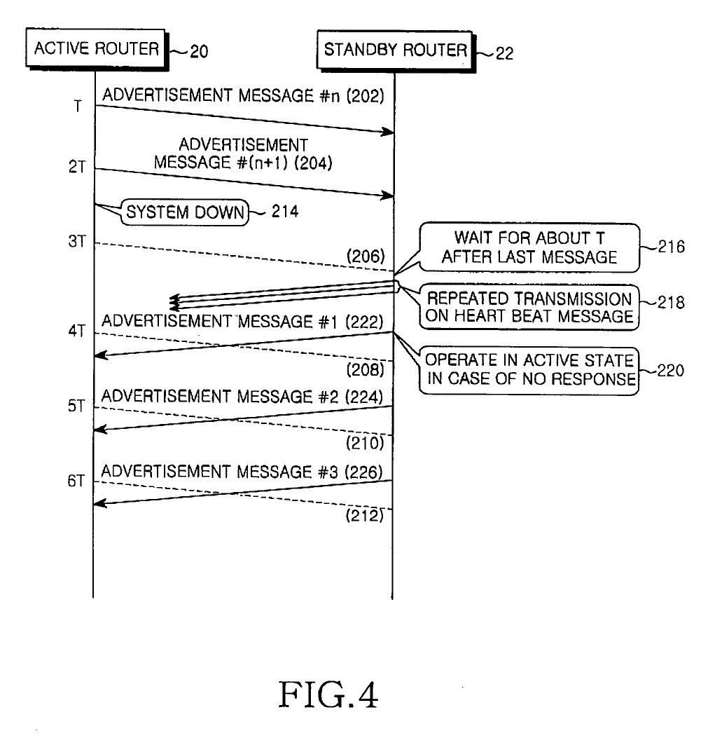

FIG. 4 is a message flow diagram illustrating a router switching operation based on a router redundancy protocol according to an embodiment of the present invention. Herein, a message exchange between an active router and a standby router is represented by a time line.

Referring to FIG. 4, in steps 202 and 204, an active router transmits an advertisement message to a standby router every period T and 2T. If the active router continuously maintains a normal state, the active router continuously transmits an advertisement message by periods at 3T, 4T, 5T and 6T in steps 206 to 212. The standby router maintains a standby state while it receives the periodic advertisement message.

If a failure such as a system down occurs in the active router in step 214 and thus the active router can no longer transmit an advertisement message, then the standby router waits for a predetermined timeout time after the last advertisement message in step 216. In an embodiment of the present invention, the timeout period is equal to a duration of the advertisement message, or equal to the sum of the duration of the advertisement message and 4*RTT. For example, if a duration of the advertisement message is 1 second, the standby router waits for about 1 second because in a local area network, 1RTT is generally a very short time in units of a millisecond (ms).

If no additional advertisement message is received until the timeout period expires, the standby router continuously repeatedly transmits a heart beat message a predetermined number of times in step 218 in order to operate as an active router. If no response to the heart beat message is received for a predetermined response waiting time in step 220, the standby router operates as an active router and transmits a periodic advertisement message in steps 222, 224 and 226. In this case, the previous active router switches to a standby router and receives the advertisement message to determine whether it will switch back to the active router. In an embodiment of the present invention, the response waiting time is set to 4*RTT.

As previously described, the active router is similar in operation to the active router described in connection with FIG. 3, except that upon receiving a heart beat message from the standby router, the active router transmits a response message.

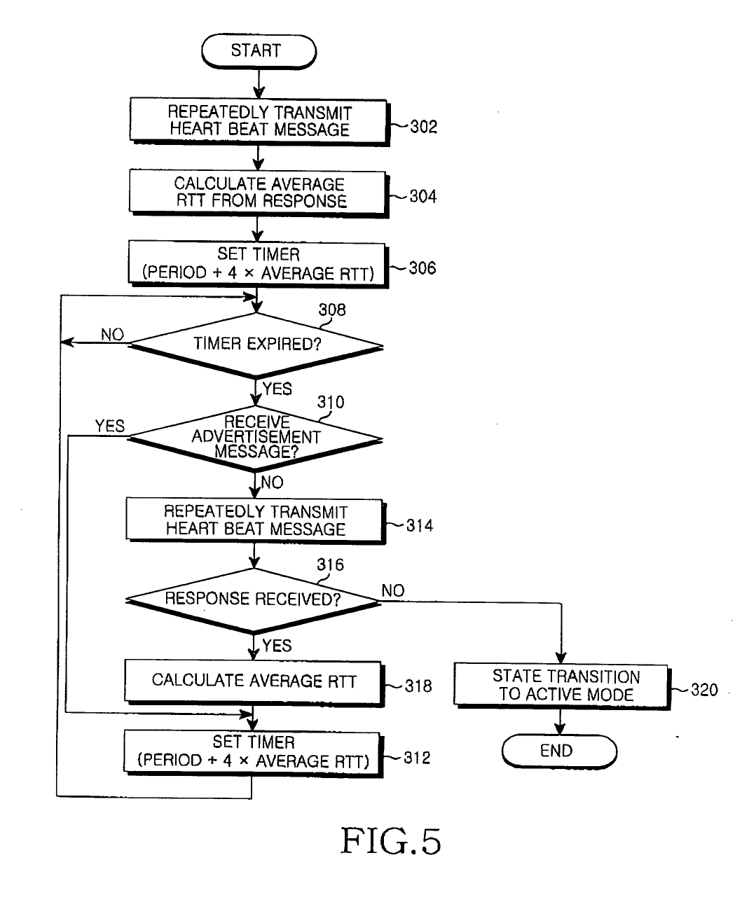

FIG. 5 is a flowchart illustrating an operation of a standby router according to an embodiment of the present invention. Referring to FIG. 5, in step 302, the standby router repeatedly transmits a heart beat message a predetermined number of times, e.g., 5 times, in order to obtain an average transmission delay between the standby router and an active router. In step 304, the standby router calculates an average RTT from an arrival time of a response to the heart beat messages. The average RTT is an average of the values obtained by dividing a period between a time when the heart beat messages were transmitted and a time when response messages corresponding thereto were received by 2. In step 306, a timer for waiting for an advertisement message is set to a value determined by adding a predetermined skew time to a predetermined duration of the advertisement message. The skew time is set to 4 times the average RTT calculated in step 304 (4*RTT).

In step 308, the standby router waits until the timer expires, and in step 310, the standby router determines whether an advertisement message has been received from the active router before expiration of the timer. If the advertisement message has been received, the standby router resets the timer in step 312 while maintaining the standby state, and then returns to step 308.

If no advertisement message has been received until expiration of the timer in step 308, the standby router repeatedly transmits a heart beat message to the active router a predetermined number of times, e.g., 3 times, in step 314, and then waits for a response to the heart beat messages in step 316. If a response to the heart beat messages is received within a predetermined skew time, e.g., 4 times the average RTT, then the standby router re-calculates an average RTT using the response in step 318, and then proceeds to step 312. However, if no response to the heart beat messages is received, the standby router makes a transition to an active state in step 320.

A set value ‘Timeout’ of a timer used for waiting for an advertisement message by the standby router is calculated by
Timeout=period+4*ARTT (1)

In Equation (1), ‘period’ denotes a period for which an active router transmits an advertisement message, and ARTT denotes average RTT. The average RTT needed for setting a timer is averaged using a Low-Pass Filtering formula. That is, the average RTT (ARTT) is defined as
ARTT(i)=(1−α)*ARTT(i−1)+α*RTT(i) (2)

In Equation (2), RTT(i) denotes RTT calculated at a current measurement period, ARTT denotes average RTT, and ‘i’ denotes an index identifying a measurement period. That is, ARRT(i−1) represents previously measured average RTT, and ARTT(i) represents newly measured average RTT. Further, α denotes a weight having a value between 0 and 1, and as this value is larger, an influence of the last calculated RTT(i) is increased. It is preferable that α0 is set to a value between 0.5 and 0.9. For example, a is set to 0.75.

The standby router initially sends five consecutive heart beat messages to thereby measure average RTT. Here, an RTT value becomes a time in units of a millisecond (ms) because the RTT represents a time for which packet trips between routers in a local area network.

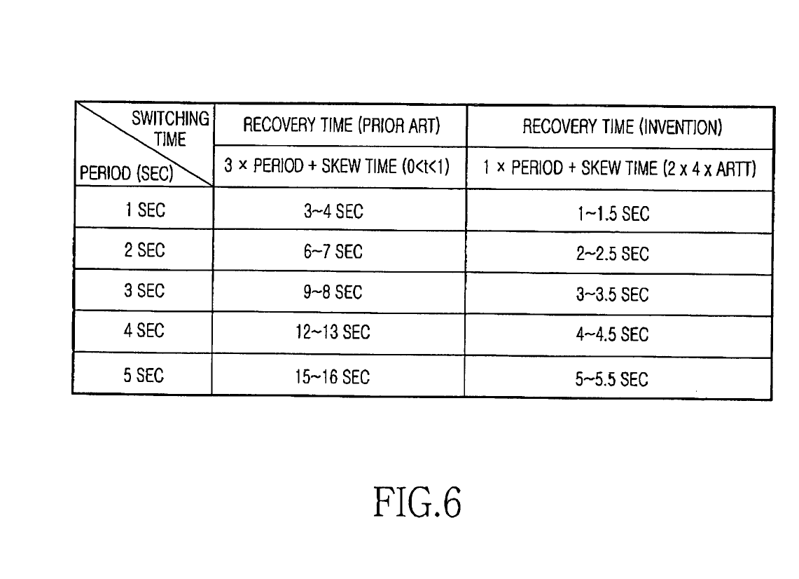

FIG. 6 is a diagram illustrating a comparison between the conventional technology and an embodiment of the present invention in terms of an expected recovery time based on a variation in duration of an advertisement message. Recovery times used in the conventional technology and an embodiment of the present invention are represented by Equation (3) and Equation (4), respectively.
Recovery=3*period+skewtime (3)

In Equation (3), ‘period’ denotes a transmission period or duration of an advertisement message, and ‘skewtime’ denotes a skew time between 0 and 1 second.
Recovery=1*period+2*4*ARTT (4)

In Equation (4), ‘period’ denotes a period or duration of an advertisement message, and ARTT denotes average RTT calculated by Equation (1). Further, the reason for waiting for two times the 4*ARTT is because the standby router should wait for 4*ARRT two times for a response to the heart beat messages while the heart beat message is repeatedly transmitted three times.

As illustrated in FIG. 6, when a period of an advertisement message is 1 second, a recovery time in the conventional technology is 3 to 4 seconds, whereas a recovery time in an embodiment of the present invention is 1 to 1.5 seconds which is no more than ⅓ of the recovery time in the conventional technology. If a period of an advertisement message is 5 seconds, a recovery time in an embodiment of the present invention is 5 to 5.5 seconds which is remarkably shorter than the recovery time of 15 to 16 seconds in the conventional technology.

As previously described, the method according to embodiments of the present invention contributes to high availability of a router by minimizing a recovery time from the time of occurrence of a failure of an active router to the time a standby router takes over.

As is understood from the foregoing description, a redundancy method for a default router of hosts in a local area network (LAN) reduces a timeout time of an advertisement message received from an active router to ⅓, and detects a state of the active router as fast as possible by a heart beat message from a standby router. In this manner, embodiments of the present invention contributes to high availability of a router system by minimizing a recovery time from a failure occurrence time of the active router to an operation time of the standby router.

While the invention has been shown and described with reference to certain embodiments thereof, it should be understood by those skilled in the art that various changes in form and details may be made therein without departing from the spirit and scope of the invention as defined by the appended claims.

1. A state transition method by a standby router in a router redundancy system including an active router and at least one standby router, the method comprising the steps of:
determining whether a periodic advertisement message is received from the active router within a predetermined timeout period;
repeatedly transmitting a heart beat message to the active router a predetermined number of times upon failure to receive the advertisement message; and
transitioning to an active state if a response to the heart beat message is not received within a predetermined waiting time after repeated transmissions of the heart beat message.

2. The method of claim 1, wherein the timeout period is set to a value determined by adding a predetermined skew time to a period for which the active router transmits the advertisement message.

3. The method of claim 2, wherein the skew time is set to a multiple of an average round trip time between the standby router and the active router.

4. The method of claim 3, wherein the average round trip time is determined by
ARTT(i)=(1−α)*ARTT( i−1)+α*RTT(i)
where RTT denotes a round trip time calculated at a current measurement period, ARTT denotes an average round trip time, ‘i’ denotes an index identifying a measurement period, and a denotes a weight set to a value between 0.5 and 0.9.

5. The method of claim 1, wherein the transmission step comprises the step of repeatedly transmitting the heart beat message a predetermined number of times.

6. The method of claim 1, wherein the waiting time is set to a multiple of an average round trip time between the standby router and the active router.

7. The method of claim 6, wherein the average round trip time is determined by
ARTT(i)=(1−α)*ARTT(i−1)+α*RTT(i)
where RTT denotes a round trip time calculated at a current measurement period, ARTT denotes an average round trip time, ‘i’ denotes an index identifying a measurement period, and α denotes a weight set to a value between 0.5 and 0.9.

8. The method of claim 1, further comprising the step of maintaining a standby state if an advertisement message is received from the active router within the timeout period.

9. A router redundancy system comprising:
an active router for transmitting a periodic advertisement message; and
at least one standby router for determining whether a periodic advertisement message is received from the active router within a predetermined timeout period, repeatedly transmitting a heart beat message to the active router a predetermined number of times if the advertisement message is not received, and transitioning to an active state if a response to the heart beat message is not received within a predetermined waiting time after repeated transmission of the heart beat message.

10. The router redundancy system of claim 9, wherein the timeout period is set to a value determined by adding a predetermined skew time to a period for which the active router transmits the advertisement message.

11. The router redundancy system of claim 10, wherein the skew time is set to a multiple of an average round trip time between the standby router and the active router.

12. The router redundancy system of claim 11, wherein the average round trip time is determined by
ARTT(i)=(1−α)*ARTT(i−1)+α*RTT(i)
where RTT denotes a round trip time calculated at a current measurement period, ARTT denotes an average round trip time, ‘i’ denotes an index identifying a measurement period, and α denotes a weight set to a value between 0.5 and 0.9.

13. The router redundancy system of claim 9, wherein the standby router repeatedly transmits the heart beat message a predetermined number of times.

14. The router redundancy system of claim 9, wherein the waiting time is set to a multiple of an average round trip time between the standby router and the active router.

15. The router redundancy system of claim 14, wherein the average round trip time is determined by
ARTT(i)=(1−α)*ARTT(i−1)+α*RTT(i)
where RTT denotes a round trip time calculated at a current measurement period, ARTT denotes an average round trip time, ‘i’ denotes an index identifying a measurement period, and a denotes a weight set to a value between 0.5 and 0.9.

16. The router redundancy system of claim 9, wherein the standby router holds a standby state if an advertisement message is received from the active router within the timeout period.
